(19) United States
(12) Patent Application Publication
(10) Pub. No.: US 2003/0132857 A1
(43) Pub. Date: Jul. 17, 2003

(54) On-board short-range communication apparatus

(75) Inventor: Yuichiro Kawamoto, Kanagawa-ken (JP)

Correspondence Address: McDERMOTT, WILL & EMERY, 600 13th Street, N.W., Washington, DC, 20005-3096, US

(73) Assignee: Nissan Motor Co., Ltd.

(21) Appl. No.: 10/337,773

(22) Filed: Jan. 8, 2003

(30) Foreign Application Priority Data
Jan. 16, 2002 (JP) P2002-007756

(51) Int. Cl. G08G 1/09

(52) U.S. Cl. 340/905

(57) ABSTRACT

A method and apparatus for performing data communication between an on-board short-range communication apparatus 1, which is able to comply with a plurality of applications, and an on-road device 2 located in the vicinity of a road on which a vehicle travels, is disclosed. A data analyzing and controlling unit 3 is operative to permit an information providing unit 10 to provide information of entire one of or a portion of the applications installed in the on-board short-range communication apparatus in response to turning-on of an electric power supply 5 of the apparatus and to provide information of entire one of or a portion of the applications prepared in an IC card 12 responsive to insertion of the IC card to an IC card read out unit 6.

### BACKGROUND OF THE INVENTION

The present invention relates to an on-board short-range communication apparatus that complies with a plurality of applications.

For the purpose of providing a driver, of a vehicle that travels on a road, with road and traffic information such as positional information and traffic jams, attempts have heretofore been made to provide a dedicated short-range communication system (DSRC: Dedicated Short-range Communication) that achieves communication between an on-road device located on the road and the on-board apparatus mounted on the vehicle through the use of optical rays or radio waves. In general, one of these examples includes an automatic toll collection system (hereinafter referred to as “ETC”) that is in practical use.

The ETC serves a system that, when the vehicle passes across a toll gate of a toll road, enables a toll collection in an automatic fashion through radio communication between an on-road radio communication device, located in the toll gate, and the vehicle.

The ETC is comprised of an apparatus that performs radio communication between the vehicle and the on-road device to interchange information necessary for the toll collection. This apparatus is hereinafter referred to as an on-board apparatus. The on-board apparatus includes an IC card interface such that inserting an IC card into the on-board apparatus enables the on-board apparatus to retrieve a recorded content of the IC card and write in external information in a non-contact manner through the use of an external radio communication.

### SUMMARY OF THE INVENTION

By the way, although an application for the related art short-range communication (hereinafter referred to as DSRC) includes only the ETC (automatic toll collection) system, recently, considerable studying works have been undertaken to develop various applications to which a DSRC technology of the ETC is applied. That is, development works have proceeded to render the on-board apparatus to have multiple-application capabilities.

However, when using the on-board apparatus complied with the multiple-application capabilities, an issue is encountered in finding out which application is complied with the on-board apparatus.

Further, in a case where there are a plurality of applications that need the IC card, another issue is encountered in finding out which application is to be finally available in the IC card, of the type complied with the multiple-application capabilities, that is inserted to the on-board apparatus.

Furthermore, still another issue resides in a difficulty in finding out, which is a non-available application.

Moreover, when achieving the short-range communication while passing across the vicinity of an antenna of the on-road device, it is probable for a user to encounter a difficulty in finding out which application is in communication with received data.

The present invention has been completed with a view to addressing the above issues encountered in the related art and has an object to provide an on-board short-range communication system and an on-board short-range communication method that, in a case where there are a plurality of associated applications, enable a user to easily recognize between an available application and a non-available application.

To achieve the above object, a first aspect of the invention provides an on-board short-range communication apparatus, for a vehicle, which is able to comply with a plurality of applications and performs data communication with an on-road device located in the vicinity of a road on which the vehicle travels, comprising a data communication processing unit transmitting and receiving the data to and from the on-road device, a data analyzing and controlling unit analyzing and controlling data processed with the data communication processing unit, and a data informing unit providing information of resulting data processed with the data analyzing and controlling unit, wherein, when turning on an electric power supply of the on-board short-range communication apparatus, the data analyzing and controlling unit is operative to extract assortments of the applications installed in the on-board short-range communication apparatus and to permit the data informing unit to provide information of the assortments of extracted applications.

A second aspect of the invention provides an on-board short-range communication apparatus, for a vehicle, which is able to comply with a plurality of applications and performs data communication with an on-road device located in the vicinity of a road on which the vehicle travels, comprising a data communication processing unit transmitting and receiving the data to and from the on-road device, a data analyzing and controlling unit analyzing and controlling data processed with the data communication processing unit, a data informing unit providing information of resulting data processed with the data analyzing and controlling unit, and an IC card read out unit reading out an IC card prepared for the applications, wherein, when the IC card is inserted to the IC card read out unit, the data analyzing and controlling unit is operative to extract assortments of the applications associated with the IC card that is inserted and to permit the data informing unit to provide information of the assortments of extracted applications.

A third aspect of the invention provides an on-board short-range communication apparatus, for a vehicle, which is able to comply with a plurality of applications and performs data communication with an on-road device located in the vicinity of a road on which the vehicle travels, comprising a data communication processing unit transmitting and receiving the data to and from the on-road device, a data analyzing and controlling unit analyzing and controlling data processed with the data communication processing unit, a data informing unit providing information of resulting data processed with the data analyzing and controlling unit, and an IC card read out unit reading out an IC card prepared for the applications, wherein, when the IC card is inserted to the IC card read out unit, the data analyzing and controlling unit is operative to extract assortments of the applications installed in the on-board short-range communication apparatus and assortments of the applications associated with the IC card that is inserted whereupon the data analyzing and controlling unit permits the data informing unit to provide information of the assortments of extracted applications, among the assortments of the applications, that are currently available to be used in combination between the on-board short-range communication apparatus and the IC card.

A fourth aspect of the invention provides an on-board short-range communication apparatus, for a vehicle, which is able to comply with a plurality of applications and performs data communication with an on-road device located in the vicinity of a road on which the vehicle travels, comprising a data communication processing unit transmitting and receiving the data to and from the on-road device, a data analyzing and controlling unit analyzing and controlling data processed with the data communication processing unit, a data informing unit providing information of resulting data processed with the data analyzing and controlling unit, and an IC card read out unit reading out an IC card prepared for the applications, wherein, when the IC card is inserted to the IC card read out unit, the data analyzing and controlling unit is operative to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, the data analyzing and controlling unit permits the data informing unit to provide information of the presence of the non-available application.

A fifth aspect of the invention provides an on-board short-range communication apparatus, for a vehicle, which is able to comply with a plurality of applications and performs data communication with an on-road device located in the vicinity of a road on which the vehicle travels, comprising a data communication processing unit transmitting and receiving the data to and from the on-road device, a data analyzing and controlling unit analyzing and controlling data processed with the data communication processing unit, a data informing unit providing information of resulting data processed with the data analyzing and controlling unit, and an IC card read out unit reading out an IC card prepared for the applications, wherein, when the IC card is inserted to the IC card read out unit, the data analyzing and controlling unit is operative to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, the data analyzing and controlling unit permits the data informing unit to provide information of an assortment of the non-available application.

A sixth aspect of the invention provides an on-board short-range communication apparatus, for a vehicle, which is able to comply with a plurality of applications and performs data communication with an on-road device located in the vicinity of a road on which the vehicle travels, comprising a data communication processing unit transmitting and receiving the data to and from the on-road device, a data analyzing and controlling unit analyzing and controlling data processed with the data communication processing unit, a data informing unit providing information of resulting data processed with the data analyzing and controlling unit, and an IC card read out unit reading out an IC card prepared for the applications, wherein, when the IC card is inserted to the IC card read out unit, the data analyzing and controlling unit is operative to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated the on-board short-range communication apparatus but not with the IC card, the data analyzing and controlling unit permits the data informing unit to provide information of an assortment of the non-available application.

A seventh aspect of the invention provides an on-board short-range communication apparatus, for a vehicle, which is able to comply with a plurality of applications and performs data communication with an on-road device located in the vicinity of a road on which the vehicle travels, comprising a data communication processing unit transmitting and receiving the data to and from the on-road device, a data analyzing and controlling unit analyzing and controlling data processed with the data communication processing unit, a data informing unit providing information of resulting data processed with the data analyzing and controlling unit, and an IC card read out unit reading out an IC card prepared for the applications, wherein, when the IC card is inserted to the IC card read out unit, the data analyzing and controlling unit is operative to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated with the IC card but not with the on-board short-range communication apparatus, the data analyzing and controlling unit permits the data informing unit to provide information of an assortment of the non-available application.

An eighth aspect of the invention provides an on-board short-range communication apparatus, for a vehicle, which is able to comply with a plurality of applications and performs data communication with an on-road device located in the vicinity of a road on which the vehicle travels, comprising a data communication processing unit transmitting and receiving the data to and from the on-road device, a data analyzing and controlling unit analyzing and controlling data processed with the data communication processing unit, and a data informing unit providing information of resulting data processed with the data analyzing and controlling unit, wherein, when the vehicle enters a communication area of the on-road device, the data analyzing and controlling unit judges assortments of the applications of data that is transmitted to and received from the on-road device through the data communication processing unit to permit the data informing unit to provide information of the assortments of the applications.

A ninth aspect of the invention provides a method of performing data communication between an on-board short-range communication apparatus for a vehicle, which is able to comply with a plurality of applications, and an on-road device located in the vicinity of a road on which the vehicle travels, the method comprising processing the data for transmitting and receiving the data to and from the on-road device, analyzing and controlling data processed in the data processing step, and providing information of resulting data processed in the data analyzing and controlling step, wherein, when turning on an electric power supply of the on-board short-range communication apparatus, analyzing and controlling of data is executed to extract assortments of the applications installed in the on-board short-range communication apparatus and to permit information of the assortments of extracted applications to be provided.

An tenth aspect of the invention provides a method of performing data communication between an on-board short-range communication apparatus for a vehicle, which is able to comply with a plurality of applications, and an on-road device located in the vicinity of a road on which the vehicle travels, the method comprising processing the data for transmitting and receiving the data to and from the on-road device, analyzing and controlling data processed in the data processing step, providing information of resulting data processed in the data analyzing and controlling step, and reading out an IC card prepared for the applications, wherein, when the IC card is inserted into a given position, analyzing and controlling is executed to extract assortments of the applications associated with the IC card that is inserted and to permit information of the assortments of extracted application to be provided.

A eleventh aspect of the invention provides a method of performing data communication between an on-board short-range communication apparatus for a vehicle, which is able to comply with a plurality of applications, and an on-road device located in the vicinity of a road on which the vehicle travels, the method comprising processing the data for transmitting and receiving the data to and from the on-road device, analyzing and controlling data processed in the data processing step, providing information of resulting data processed in the data analyzing and controlling step, and reading out an IC card prepared for the applications, wherein, when the IC card is inserted into a given position, analyzing and controlling is executed to extract assortments of the applications installed in the on-board short-range communication apparatus and assortments of the applications associated with the IC card that is inserted whereupon analyzing and controlling is further executed to permit information of the assortments of extracted applications, among the assortments of the applications, that are currently available in combination between the on-board short-range communication apparatus and the IC card to be provided.

A twelfth aspect of the invention provides a method of performing data communication between an on-board short-range communication apparatus for a vehicle, which is able to comply with a plurality of applications, and an on-road device located in the vicinity of a road on which the vehicle travels, the method comprising processing the data for transmitting and receiving the data to and from the on-road device, analyzing and controlling data processed in the data processing step, providing information of resulting data processed in the data analyzing and controlling step, and reading out an IC card prepared for the applications, wherein, when the IC card is inserted into a given position, analyzing and controlling is executed to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, analyzing and controlling is further executed to permit information of the presence of the non-available application to be provided.

A thirteenth aspect of the invention provides a method of performing data communication between an on-board short-range communication apparatus for a vehicle, which is able to comply with a plurality of applications, and an on-road device located in the vicinity of a road on which the vehicle travels, the method comprising processing the data for transmitting and receiving the data to and from the on-road device, analyzing and controlling data processed in the data processing step, providing information of resulting data processed in the data analyzing and controlling step, and reading out an IC card prepared for the applications, wherein, when the IC card is inserted into a given position, analyzing and controlling executed to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, analyzing and controlling is further executed to permit information of an assortment of the non-available application to be provided.

A fourteenth aspect of the invention provides a method of performing data communication between an on-board short-range communication apparatus for a vehicle, which is able to comply with a plurality of applications, and an on-road device located in the vicinity of a road on which the vehicle travels, the method comprising processing the data for transmitting and receiving the data to and from the on-road device, analyzing and controlling data processed in the data processing step, providing information of resulting data processed in the data analyzing and controlling step, and reading out an IC card prepared for the applications, wherein, when the IC card is inserted into a given position, analyzing and controlling is executed to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated the on-board short-range communication apparatus but not with the IC card, analyzing and controlling is further executed to permit information of an assortment of the non-available application to be provided.

A fifteenth aspect of the invention provides a method of performing data communication between an on-board short-range communication apparatus for a vehicle, which is able to comply with a plurality of applications, and an on-road device located in the vicinity of a road on which the vehicle travels, the method comprising processing the data for transmitting and receiving the data to and from the on-road device, analyzing and controlling data processed in the data processing step, providing information of resulting data processed in the data analyzing and controlling step, and reading out an IC card prepared for the applications, wherein, when the IC card is inserted into a given position, analyzing and controlling is executed to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated with the IC card but not with the on-board short-range communication apparatus, analyzing and controlling is further executed to permit information of an assortment of the non-available application to be provided.

A sixteenth aspect of the invention provides a method of performing data communication between an on-board short-range communication apparatus for a vehicle, which is able to comply with a plurality of applications, and an on-road device located in the vicinity of a road on which the vehicle travels, the method comprising processing data communication for transmitting and receiving the data to and from the on-road device, analyzing and controlling data processed in the data communication processing step, and providing information of resulting data processed in the analyzing and controlling step, wherein, when the vehicle enters a communication area of the on-road device, analyzing and controlling is executed to judge assortments of the applications of data that is transmitted to and received from the on-road device in the data communication processing step to permit information of the assortments of the applications to be provided.

### BRIEF DESCRIPTION OF THE DRAWINGS

FIG. 1 is a block diagram illustrating an overall structure of an on-board short-range communication apparatus for various embodiments according to the present invention.

FIG. 2 is a flowchart illustrating the basic sequence of operations of an on-board short-range communication apparatus of a first embodiment according to the present invention.

FIG. 3 is a flowchart illustrating the basic sequence of operations of an on-board short-range communication apparatus of a second embodiment according to the present invention.

FIG. 4 is a flowchart illustrating the basic sequence of operations of an on-board short-range communication apparatus of a third embodiment according to the present invention.

FIG. 5 is a flowchart illustrating the basic sequence of operations of an on-board short-range communication apparatus of a fourth embodiment according to the present invention.

FIG. 6 is a flowchart illustrating the basic sequence of operations of an on-board short-range communication apparatus of a fifth embodiment according to the present invention.

FIG. 7 is a flowchart illustrating the basic sequence of operations of an on-board short-range communication apparatus of a sixth embodiment according to the present invention.

FIG. 8 is a flowchart illustrating the basic sequence of operations of an on-board short-range communication apparatus of a seventh embodiment according to the present invention.

FIG. 9 is a flowchart illustrating the basic sequence of operations of an on-board short-range communication apparatus of an eighth embodiment according to the present invention.

### DETAILED DESCRIPTION OF THE PREFERRED EMBODIMENS

Hereinafter, various embodiments of the present invention are described with reference to the drawings.

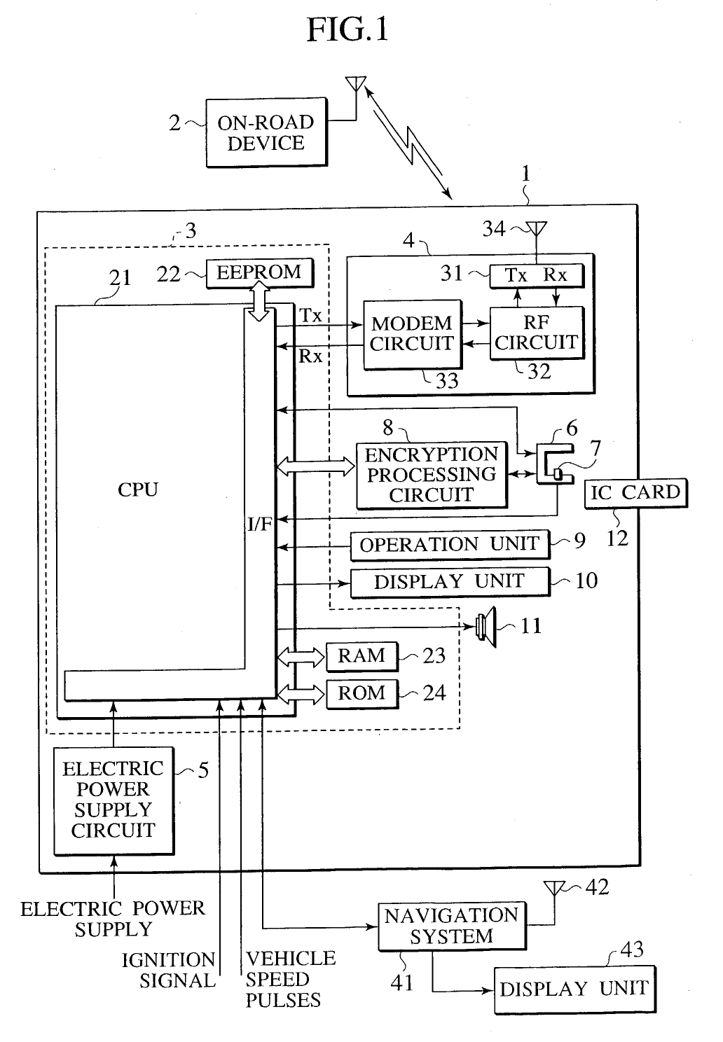

FIG. 1 is a block diagram illustrating an overall structure of an on-board short-range communication apparatus for various embodiments, according to the present invention, which are described below.

As shown in FIG. 1, the on-board short-range communication apparatus 1 is mounted on an automobile, a motor vehicle, a car or the like and serves to communicate with an on-road device 2, which is installed in close proximity to a road on which a vehicle travels, to achieve transmission/reception of data. The on-board short-range communication apparatus 1 includes a control circuit 3 that totally controls operations of the on-board short-range communication apparatus 1, a data communication processing unit 4 that executes operations of transmission and reception of data to and from the on-road device 2 and an electric power supply circuit 5.

Further, the on-board short-range communication apparatus 1 includes an IC card interface (IC card read out unit) 6 that reads out data stored in an IC card 12 correlated with various applications, a card switch 7 that detects the presence of the IC card 12 inserted to the IC card interface 6, and an encryption processing circuit 8.

Furthermore, the on-board short-range communication apparatus 1 includes an operation unit 9 that enables an operator to execute various input operations, a display unit 10, serving as a data informing unit, to provide a user with information indicative of various data analyzed with the data analyzing and controlling unit 3, and a voice output unit 11.

The control circuit 3 is comprised of a CPU 21, an EEPROM 22, a RAM 23 and a ROM 24 and serves as a data analyzing and controlling unit to analyze and control data processed with the data communication unit 4. When turning on the electric power supply of the on-board short-range communication apparatus 1, the control circuit 3 is further operative to extract assortments of applications installed in the on-board short-range communication apparatus 1 and deliver the assortment of extracted application to the data informing unit composed of the display unit 10. Also, the CPU 21 is configured to receive ignition turn-ON and turn-OFF signals, and a train of vehicle speed pulses.

The communication processing unit 4 is comprised of a transmitter/receiver unit 31, an RF circuit 32, a modem circuit 33 and an antenna 34. With this communication processing unit 4, a radio wave transmitted from the on-road device 2 is received with the antenna 34 and passed through the transmitter/receiver unit 31 to the RF circuit 32 by which the radio wave is detected and, then, delivered to the modem circuit 33 by which the radio wave is then demodulated and outputted to the control circuit 3.

Further, the control circuit 3 is connected to a navigation system 41, mounted on the vehicle, which includes a GPS antenna 42 and a display unit 43 to provide a display of a navigation screen. With such configuration, the control circuit 3 analyzes data (data as a result of demodulation) transmitted from the on-road device 2 and discriminates as to which application is correlated with such data. Here, the application includes assortments such as an information providing service, that provides an ETC (automatic toll collection system), parking-charge collection, traffic information, traffic jam information, area information and music/image delivery, and an internet connection service.

Further, the control circuit 3 operates to access the IC card 12 to make a judgment as to which application is correlated with the IC card 12 inserted into the IC card interface 6. Furthermore, the control circuit 3 executes operation to access the IC card 12 via the encryption processing circuit 8. Also, there is a probability for the control circuit 3 to process data without intervention of the IC card 12, depending on the applications.

The encryption processing circuit 8 serves to perform mutual authentication between the IC card 12 and the on-road device 2 and has a function to restore encryption data in code and encrypt communication data. Further, the encryption processing circuit 8 has a function to read out data from the IC card 12 and implement writing-in of data into the IC card 12 such that data received from the on-road device 2 is transferred through the IC card interface 6 to the IC card 12 to store data in record medium contained in the IC card 12.

The IC card 12 corresponds to various applications set forth above and includes a card that is in compliance with a plurality of applications (multi-applications) or a card only corresponding to a single application.

Upon detecting the presence of the inserted IC, the card switch 7 outputs a detection signal indicative of detection of the IC card 12 to the control circuit 3.

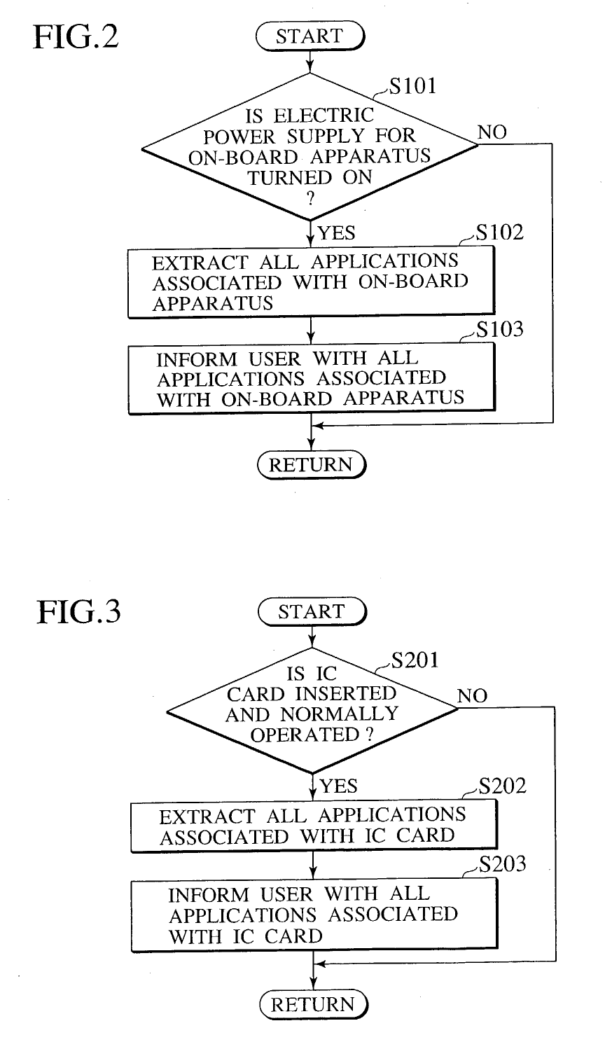

Now, the operation of the presently filed embodiment with such a structure mentioned above is described with reference to FIG. 2 that shows a flowchart illustrating the basic sequence of operations of the short-range communication apparatus 1 of the first embodiment of the invention.

First, in step S101, the on-board apparatus 1 confirms whether the power supply is turned on. Upon confirmation of the turning-on state of the power supply, then the flow is routed to operation in step S102.

In step S102, the on-board apparatus 1 retrieves the assortments of the associated applications to extract the assortments of all of the applications associated with the on-board apparatus 1.

In subsequent step S103, the on-board apparatus 1 informs all the associated applications to the user, depending on the assortments of the extracted applications.

Examples of information providing methods in such a situation may include a method of causing designations of the applications or images (in the forms of icons, pictures and photos) to be displayed over the display unit 10, and a method of causing the voice output unit 11 to produce the voice signal.

With such a structure, the user is able to know the applications that can be used in the on-board apparatus 1 whenever turning on the power supply and, therefore, the user is able to execute a quick operation. Accordingly, the presently filed embodiment is particularly effective when acquiring the associated available applications at the time of turning on the power supply of the on-board apparatus 1 or at the time of user's operation.

Next, a second embodiment of the invention is described below. FIG. 3 is a flowchart illustrating the operation of an on-board short-range communication apparatus 1 of the second embodiment.

First, in step S201, the on-board apparatus 1 confirms whether the user inserts the IC card 12 and if insertion of the IC card is confirmed, then operation is implemented to discriminate whether or not the IC card 12 is normal. If it is confirmed to be normal, then the flow is routed to operation in step S202.

In step S202, the on-board apparatus 1 retrieves the assortments of the applications associated with the IC card 12 that is inserted, thereby extracting the assortments of all the associated applications.

In subsequent step S203, the on-board apparatus 1 provides the user with information of all the applications, associated with the IC card 12 on the basis of the assortments of the extracted applications. Examples of information providing methods in such a situation may include a method of causing designations of the applications or images (icons, pictures and photos) to be displayed over the display unit 10, and a method of causing the voice output unit 11 to produce the voice signal.

With such a structure, the user is able to know the applications that can be used with the IC card 12 whenever inserting the IC card 12 and, therefore, the user is able to execute a quick operation. Accordingly, the presently filed embodiment is particularly effective when acquiring the associated applications at the time of inserting the IC card 12 or at the time of user's operation.

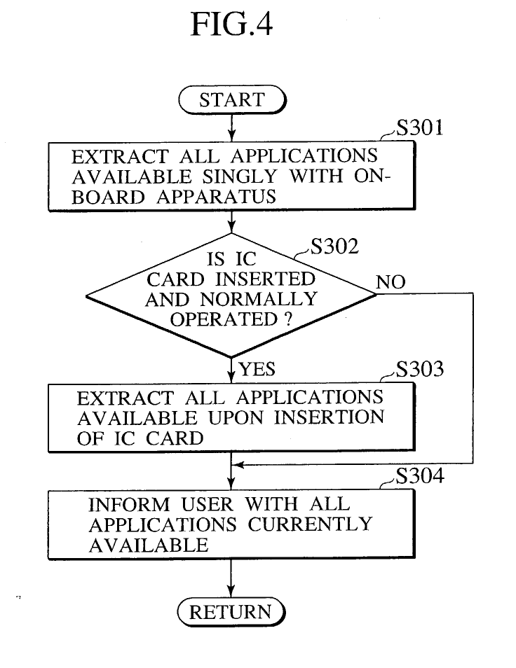

Now, a third embodiment of the invention is described. FIG. 4 is a flowchart illustrating the operation of an on-board short-range communication apparatus 1 of the third embodiment.

First, in step S301, the on-board apparatus 1 retrieves the assortments of the applications to confirm the assortments of the associated available applications. When this takes place, the on-board apparatus 1 discriminates particular applications that are available to be used singly with the on-board apparatus 1 without the use of the IC card 12, to extract all the associated applications and the applications available to be used singly with the on-board apparatus 1.

In subsequent step S302, the on-board apparatus 1 confirms whether the user correctly inserts the IC card 12, and if correct insertion of the IC card is confirmed, then operation is implemented to discriminate whether or not the IC card 12 is normal. If it is confirmed to be normal, then the flow is routed to operation in step S303.

On the contrary, if the IC card 12 is not inserted or the IC card 12 is not in normal operation, then the flow is routed to operation in step S304.

In step S303, the on-board apparatus 1 retrieves the assortments of the applications associated with the IC card 12 that is inserted, thereby extracting the assortments of all the associated applications.

In subsequent step S304, the on-board apparatus 1 provides the user with information of all the applications that are currently available based on resulting extractions in step S301 and S303. Examples of information providing methods in such a situation may include a method of causing designations of the applications or images (icons, pictures and photos) to be displayed over the display unit 10, and a method of causing the voice output unit 11 to produce the voice signal.

With such a structure, it is possible for the user to quickly know the applications that can be currently available and, therefore, the user is able to execute a rapid operation. Accordingly, the presently filed embodiment is particularly effective when acquiring the associated available applications at the time of inserting the IC card 12 or at the time of user's operation.

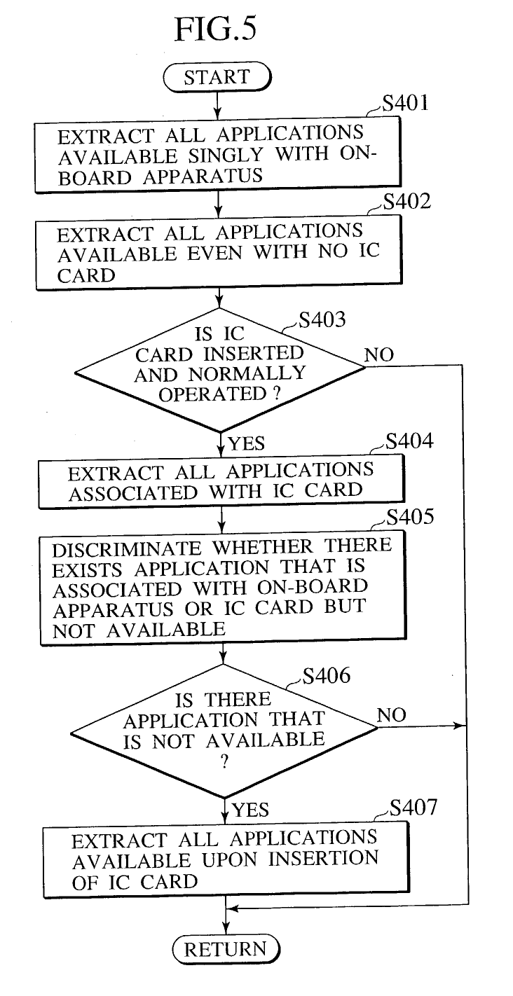

Now, a fourth embodiment of the invention is described. FIG. 5 is a flowchart illustrating the operation of an on-board short-range communication apparatus 1 of the fourth embodiment.

First, in step S401, the on-board apparatus 1 retrieves the assortments of the applications to confirm the assortments of the associated applications. When this takes place, the on-board apparatus 1 discriminates the applications associated with the on-board apparatus 1 to extract all the associated applications.

In subsequent step S402, the on-broad apparatus 1 discriminates the applications available to be used simply with the on-broad apparatus 1 without the IC card 12 to extract all the applications.

In subsequent step S403, the on-board apparatus 1 confirms whether the user correctly inserts the IC card 12 into the IC card interface 6. If insertion of the IC card 12 is confirmed, then operation is implemented to discriminate whether or not the IC card 12 is in normal operation. If it is confirmed to be normal, then the flow is routed to operation in step S404.

In step S404, the on-board apparatus 1 retrieves the assortments of the applications associated with the IC card 12 that is inserted, thereby extracting the assortments of all the associated available applications.

In step S405, the on-board apparatus 1 discriminates whether or not there are applications, which are non-available owing to the fact in that the applications are associated with either one of the on-board apparatus 1 and the IC card 12 but not associated with the other one, on the basis of results of operations of steps S401, S402 and S404.

In consecutive step S406, if there exists the application that is not available to be utilized in operation of step S405, then the flow is routed to operation in step S407.

In step S407, the on-board apparatus 1 provides the user with information indicative of the presence of the applications, which are non-available owing to the fact in that the applications are associated with either one of the on-board apparatus 1 and the IC card 12 but not associated with the other one. Examples of information providing methods in such a situation may include a method of causing designations of the applications or images (icons, pictures and photos) to be displayed over the display unit 10, and a method of causing the voice output unit 11 to produce the voice signal.

With such a structure, it is possible for the user to quickly know the applications that can be currently available and the user is able to know the presence of the applications, which are non-available owing to the fact in that the applications are associated with either one of the on-board apparatus 1 and the IC card 12 but not associated with the other one applications, and rapid operation is enabled. Accordingly, the presently filed embodiment is particularly effective when acquiring the associated available applications at the time of inserting the IC card 12 or at the time of user's operation.

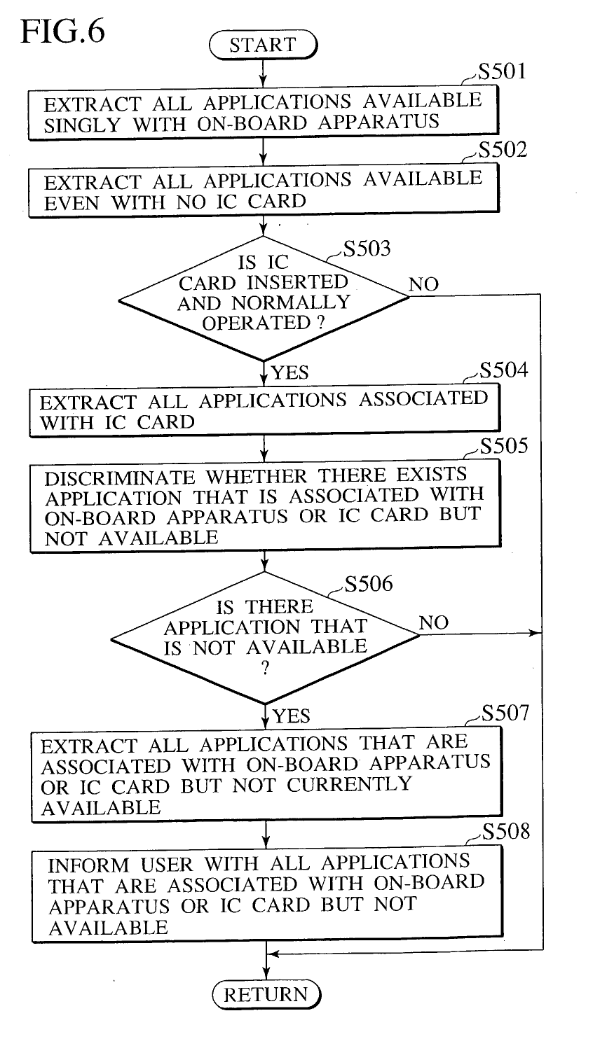

Now, a fifth embodiment of the invention is described. FIG. 6 is a flowchart illustrating the operation of an on-board short-range communication apparatus 1 of the fifth embodiment.

First, in step S501, the on-board apparatus 1 retrieves the assortments of the applications to confirm the assortments of the associated applications. And, the on-board apparatus 1 discriminates the applications associated with the on-board apparatus 1 to extract all the associated applications.

In subsequent step S502, the on-board apparatus 1 discriminates the applications available to be used simply with the on-board apparatus 1 to extract all the applications that are available without the need for the IC card 12.

In step S503, the on-board apparatus 1 confirms whether the user inserts the IC card 12 into the IC card interface 6. If insertion of the IC card is confirmed, then operation is implemented to discriminate whether or not the IC card 12 is normal. If it is confirmed to be normal, then the flow is routed to operation in step S504.

In step S504, the on-board apparatus 1 retrieves the assortments of the applications associated with the IC card 12 that is inserted, thereby extracting the assortments of all the associated applications.

In step S505, the on-board apparatus 1 discriminates whether or not there are applications, which are non-available owing to the fact in that the applications are associated with at least one of the on-board apparatus 1 and the IC card 12 but not associated with the other one, on the basis of results of operations in steps S501, S502 and S504.

In consecutive step S506, if there exists the application, in a result of step S505, that is not available to be utilized, then the flow is routed to operation in step S507.

In step S507, the on-board apparatus 1 extracts all the applications, which are non-available owing to the fact in that the applications are associated with at least one of the on-board apparatus 1 and the IC card 12 but not associated with the other one, on the basis of the results in operation of steps S501, S502 and S504 set forth above.

In step S508, the on-board apparatus 1 provides the user with information of all the applications, which are non-available owing to the fact in that the applications are associated with at least one of the on-board apparatus 1 and the IC card 12 but not associated with the other one. Examples of information methods in such a situation may include a method of causing designations of the applications or images (icons, pictures and photos) to be displayed over the display unit 10, and a method of causing the voice output unit 11 to produce the voice signal.

With such a structure, it is possible for the user to quickly know the applications that can be currently available and the user is able to know the presence of the applications, which are non-available owing to the fact in that the applications are associated with either one of the on-board apparatus 1 and the IC card 12 but not associated with the other one, and rapid operation is enabled. Accordingly, the presently filed embodiment is particularly effective when acquiring the associated applications at the time of inserting the IC card 12 or at the time of user's operation.

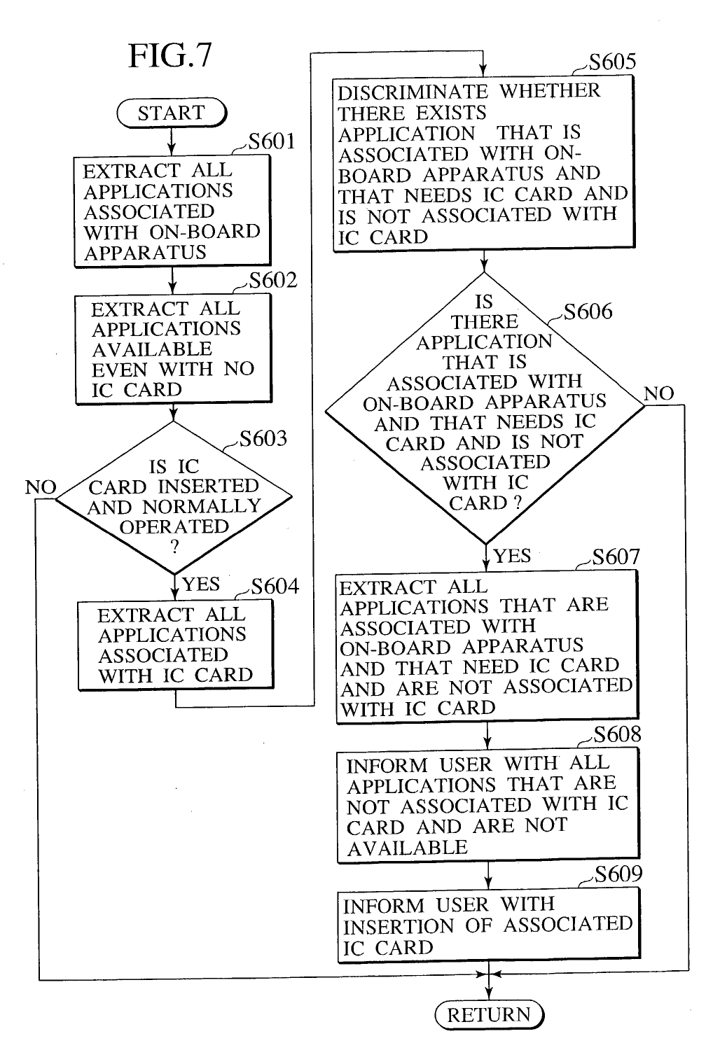

Now, a sixth embodiment of the invention is described. FIG. 7 is a flowchart illustrating the operation of an on-board short-range communication apparatus 1 of the sixth embodiment.

First, in step S601, the on-board apparatus 1 retrieves the assortments of the applications to confirm the assortments of the associated applications. And, the on-board apparatus 1 discriminates the applications associated with the on-board apparatus 1 to extract all the associated applications.

In subsequent step S602, the on-board apparatus 1 discriminates the applications available to be used simply with the on-board apparatus 1 without the need for the IC card 12 to extract all the applications.

In step S603, the on-board apparatus 1 confirms whether the user inserts the IC card 12 into the IC card interface 6. If insertion of the IC card 12 is confirmed, then operation is implemented to discriminate whether or not the IC card 12 is normal, and if it is confirmed to be normal, then the flow is routed to operation in step S604.

In step S604, the on-board apparatus 1 retrieves the assortments of the applications associated with the IC card 12 that is inserted, thereby extracting all the applications associated with the IC card 12.

In step S605, the on-board apparatus 1 discriminates whether or not there are applications, which are non-available owing to the fact in that the applications are associated with either one of the on-board apparatus 1 and the IC card 12 but not associated with the other one, on the basis of results of operations in steps S601, S602 and S604.

In consecutive step S606, if there exists the application, in a result of step S605, that is associated with the on-board apparatus 1 and is not operable singly with the on-board apparatus 1 to need the IC card 12, i.e., the application that is not associated with the IC card, then the flow is routed to operation in step S607.

In step S607, the on-board apparatus 1 extracts all the applications, which are associated with the on-board apparatus 1 but need the IC card 12 and are not associated with the IC card, on the basis of the results in operations of steps S601, S602 and S604 set forth above.

In step S608, the on-board apparatus 1 provides the user with information of all the applications, which are non-available owing to the fact in that the applications are not associated with the IC card 12, based on the result obtained in step S607. Examples of information methods in such a situation may include a method of causing designations of the applications or images (icons, pictures and photos) to be displayed over the display unit 10, and a method of causing the voice output unit 11 to produce the voice signal.

In consecutive step S609, the on-board apparatus 1 informs the user to insert the associated IC card 12 into the IC card interface 6. Examples of information methods in such a situation may include a method of causing designations of the applications or images (icons, pictures and photos) to be displayed over the display unit 10, and a method of causing the voice output unit 11 to produce the voice signal.

In such a manner, with the presently filed embodiment, since the user is able to quickly know the application that is not available to be utilized because of the fact that the application is associated with the on-board apparatus 1 but not with the IC card 12, operability is highly improved. Accordingly, the presently filed embodiment is particularly effective when acquiring the associated applications at the time of inserting the IC card 12 or at the time of user's operation.

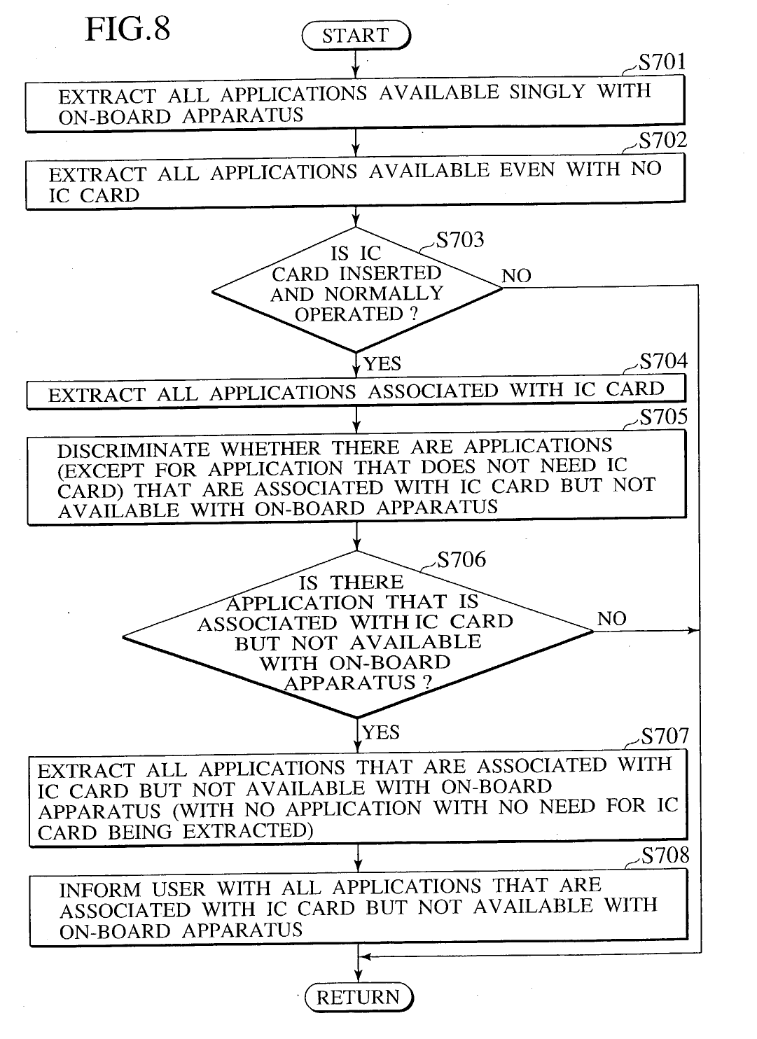

Now, a seventh embodiment of the invention is described. FIG. 8 is a flowchart illustrating the operation of an on-board short-range communication apparatus 1 of the seventh embodiment.

First, in step S701, the on-board apparatus 1 retrieves the assortments of the applications to confirm the assortments of the associated applications. And, the on-board apparatus 1 discriminates the applications associated with the on-board apparatus 1 to extract all the associated applications.

In subsequent step S702, the on-board apparatus 1 discriminates the applications available to be used simply with the on-board apparatus 1 without the need for the IC card 12 to extract all the applications.

In step S703, the on-board apparatus 1 confirms whether the user inserts the IC card 12 into the IC card interface 6. If insertion of the IC card 12 is confirmed, then operation is implemented to discriminate whether or not the IC card 12 is normal, and if it is confirmed to be normal, then the flow is routed to operation in step S704.

In step S704, the on-board apparatus 1 retrieves the assortments of the applications associated with the IC card 12 that is inserted, thereby extracting all the applications associated with the IC card 12.

In consecutive step S705, the on-board apparatus 1 discriminates whether or not there are applications, which are associated with the IC card 12 but not available to be utilized with the on-board apparatus 1, on the basis of results of operations in steps S701, S702 and S704 set forth above. When this takes place, the application available to be operated singly with the on-board apparatus 1 without the need for the IC card 12 is not included.

In succeeding step S706, if there exists the application, in a result of step S705, that is associated with the IC card 12 but is not operable with the on-board apparatus 1, then the flow is routed to operation in step S707.

In step S707, the on-board apparatus 1 extracts all the applications that are associated with the IC card 12 but are not available to be utilized with the on-board apparatus 1, on the basis of the results in operation of steps S701, S702 and S704 set forth above. When this takes place, the application with no need for the IC card 12 and operable singly with the no-board apparatus is not included.

In step S708, the on-board apparatus 1 inform the user with all the applications, based on the result obtained in step S707, that are not available to be utilized with the on-board apparatus 1 regardless of the fact that the applications are associated with the IC card 12. Examples of information methods in such a situation may include a method of causing designations of the applications or images (icons, pictures and photos) to be displayed over the display unit 10, and a method of causing the voice output unit 11 to produce the voice signal.

In such a manner, with the presently filed embodiment, since the user is able to quickly know the application that is associated with the IC card 12 but are not available to be utilized because of the fact that the application is not associated with the on-board apparatus 1, operability is highly improved. Accordingly, the presently filed embodiment is particularly effective when acquiring the associated applications at the time of inserting the IC card 12 or at the time of user's operation.

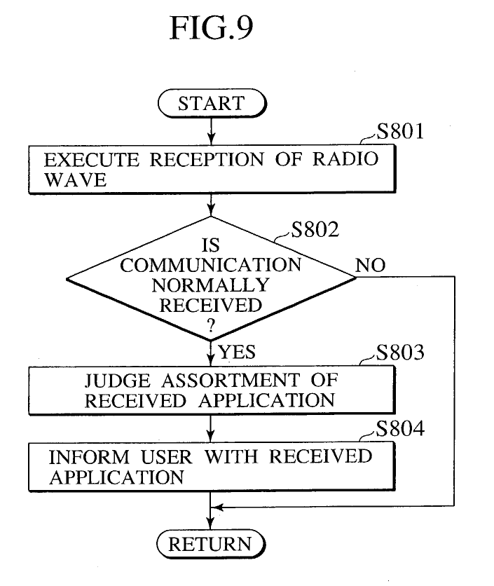

Now, an eighth embodiment of the invention is described. FIG. 9 is a flowchart illustrating the operation of an on-board short-range communication apparatus 1 of the eighth embodiment.

First in step S801, the on-board apparatus 1 operates to receive the signal delivered from the on-road device 2.

In subsequent step S802, confirmation is made as to whether communication between the on-board apparatus 1 and the on-road device 2 is normally performed. If it is confirmed to be normal, the flow is routed to step S803.

In consecutive step S803, the on-board apparatus 1 retrieves the assortments of the applications received from the on-road device 2 to discriminate the received applications.

In succeeding step S804, the on-board apparatus 1 informs the user with the applications received from the on-road device 2. Examples of information methods in such a situation may include a method of causing designations of the applications or images (icons, pictures and photos) to be displayed over the display unit 10, and a method of causing the voice output unit 11 to produce the voice signal.

In such a manner, the presently filed embodiment enables the user to confirm what is the application that is communicated. Executing operation to provide a display of an icon indicative of the start-up of the application when carrying out the communication provides a more effective result. Accordingly, the presently filed embodiment is particularly effective when acquiring the associated applications at the time of updating the communication with the on-road device 2 or at the time of user's operation.

The entire content of Japanese Patent Application No. P2002-007756 with a filing date of Jan. 16, 2002 is herein incorporated by reference.

Although the present invention has been described above by reference to certain embodiments of the invention, the invention is not limited to the embodiments described above and modifications will occur to those skilled in the art, in light of the teachings. The scope of the invention is defined with reference to the following claims.

What is claimed is:

1. An on-board short-range communication apparatus, for a vehicle, which is able to comply with a plurality of applications and performs data communication with an on-road device located in the vicinity of a road on which the vehicle travels, comprising:
a data communication processing unit transmitting and receiving the data to and from the on-road device;
a data analyzing and controlling unit analyzing and controlling data processed with the data communication processing unit; and
a data informing unit providing information of resulting data processed with the data analyzing and controlling unit;
wherein, when turning on an electric power supply of the on-board short-range communication apparatus, the data analyzing and controlling unit is operative to extract assortments of the applications installed in the on-board short-range communication apparatus and to permit the data informing unit to provide information of the assortments of extracted applications.

2. An on-board short-range communication apparatus, for a vehicle, which is able to comply with a plurality of applications and performs data communication with an on-road device located in the vicinity of a road on which the vehicle travels, comprising:
a data communication processing unit transmitting and receiving the data to and from the on-road device;
a data analyzing and controlling unit analyzing and controlling data processed with the data communication processing unit;
a data informing unit providing information of resulting data processed with the data analyzing and controlling unit; and
an IC card read out unit reading out an IC card prepared for the applications;
wherein, when the IC card is inserted to the IC card read out unit, the data analyzing and controlling unit is operative to extract assortments of the applications associated with the IC card that is inserted and to permit the data informing unit to provide information of the assortments of extracted applications.

3. An on-board short-range communication apparatus, for a vehicle, which is able to comply with a plurality of applications and performs data communication with an on-road device located in the vicinity of a road on which the vehicle travels, comprising:
a data communication processing unit transmitting and receiving the data to and from the on-road device;
a data analyzing and controlling unit analyzing and controlling data processed with the data communication processing unit;
a data informing unit providing information of resulting data processed with the data analyzing and controlling unit; and
an IC card read out unit reading out an IC card prepared for the applications;
wherein, when the IC card is inserted to the IC card read out unit, the data analyzing and controlling unit is operative to extract assortments of the applications installed in the on-board short-range communication apparatus and assortments of the applications associated with the IC card that is inserted whereupon the data analyzing and controlling unit permits the data informing unit to provide information of the assortments of extracted applications, among the assortments of the applications, that are currently available to be used in combination between the on-board short-range communication apparatus and the IC card.

4. An on-board short-range communication apparatus, for a vehicle, which is able to comply with a plurality of applications and performs data communication with an on-road device located in the vicinity of a road on which the vehicle travels, comprising:
a data communication processing unit transmitting and receiving the data to and from the on-road device;
a data analyzing and controlling unit analyzing and controlling data processed with the data communication processing unit;
a data informing unit providing information of resulting data processed with the data analyzing and controlling unit; and
an IC card read out unit reading out an IC card prepared for the applications;
wherein, when the IC card is inserted to the IC card read out unit, the data analyzing and controlling unit is operative to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, the data analyzing and controlling unit permits the data informing unit to provide information of the presence of the non-available application.

5. An on-board short-range communication apparatus, for a vehicle, which is able to comply with a plurality of applications and performs data communication with an on-road device located in the vicinity of a road on which the vehicle travels, comprising:
a data communication processing unit transmitting and receiving the data to and from the on-road device;
a data analyzing and controlling unit analyzing and controlling data processed with the data communication processing unit; a data informing unit providing information of resulting data processed with the data analyzing and controlling unit; and
an IC card read out unit reading out an IC card prepared for the applications;
wherein, when the IC card is inserted to the IC card read out unit, the data analyzing and controlling unit is operative to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, the data analyzing and controlling unit permits the data informing unit to provide information of an assortment of the non-available application.

6. An on-board short-range communication apparatus, for a vehicle, which is able to comply with a plurality of applications and performs data communication with an on-road device located in the vicinity of a road on which the vehicle travels, comprising:
a data communication processing unit transmitting and receiving the data to and from the on-road device;
a data analyzing and controlling unit analyzing and controlling data processed with the data communication processing unit;
a data informing unit providing information of resulting data processed with the data analyzing and controlling unit; and
an IC card read out unit reading out an IC card prepared for the applications;
wherein, when the IC card is inserted to the IC card read out unit, the data analyzing and controlling unit is operative to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated the on-board short-range communication apparatus but not with the IC card, the data analyzing and controlling unit permits the data informing unit to provide information of an assortment of the non-available application.

7. An on-board short-range communication apparatus, for a vehicle, which is able to comply with a plurality of applications and performs data communication with an on-road device located in the vicinity of a road on which the vehicle travels, comprising:
a data communication processing unit transmitting and receiving the data to and from the on-road device;
a data analyzing and controlling unit analyzing and controlling data processed with the data communication processing unit;
a data informing unit providing information of resulting data processed with the data analyzing and controlling unit; and
an IC card read out unit reading out an IC card prepared for the applications;
wherein, when the IC card is inserted to the IC card read out unit, the data analyzing and controlling unit is operative to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated with the IC card but not with the on-board short-range communication apparatus, the data analyzing and controlling unit permits the data informing unit to provide information of an assortment of the non-available application.

8. An on-board short-range communication apparatus, for a vehicle, which is able to comply with a plurality of applications and performs data communication with an on-road device located in the vicinity of a road on which the vehicle travels, comprising:
a data communication processing unit transmitting and receiving the data to and from the on-road device;
a data analyzing and controlling unit analyzing and controlling data processed with the data communication processing unit; and
a data informing unit providing information of resulting data processed with the data analyzing and controlling unit;
wherein, when the vehicle enters a communication area of the on-road device, the data analyzing and controlling unit judges assortments of the applications of data that is transmitted to and received from the on-road device through the data communication processing unit to permit the data informing unit to provide information of the assortments of the applications.

9. An on-board short-range communication apparatus, for a vehicle, which is able to comply with a plurality of applications and performs data communication with an on-road device located in the vicinity of a road on which the vehicle travels, comprising:
data communication means for transmitting and receiving the data to and from the on-road device;
data analyzing and controlling means analyzing and controlling data processed with the data communication processing means; and data informing means providing information of resulting data processed with the data analyzing and controlling means;
wherein, when turning on an electric power supply of the on-board short-range communication apparatus, the data analyzing and controlling means is operative to extract assortments of the applications installed in the on-board short-range communication apparatus and to permit the data informing means to provide information of the assortments of extracted applications.

10. An on-board short-range communication apparatus, for a vehicle, which is able to comply with a plurality of applications and performs data communication with an on-road device located in the vicinity of a road on which the vehicle travels, comprising:
data communication processing means for transmitting and receiving the data to and from the on-road device;
data analyzing and controlling means analyzing and controlling data processed with the data communication processing means;
data informing means providing information of resulting data processed with the data analyzing and controlling means; and
IC card read out means reading out an IC card prepared for the applications;
wherein, when the IC card is inserted to the IC card read out means, the data analyzing and controlling means is operative to extract assortments of the applications associated with the IC card that is inserted and to permit the data informing means to provide information of the assortments of extracted application.

11. An on-board short-range communication apparatus, for a vehicle, which is able to comply with a plurality of applications and performs data communication with an on-road device located in the vicinity of a road on which the vehicle travels, comprising:
data communication processing for transmitting and receiving the data to and from the on-road device;
data analyzing and controlling means analyzing and controlling data processed with the data communication processing means;
data informing means providing information of resulting data processed with the data analyzing and controlling means; and
IC card read out means reading out an IC card prepared for the applications;
wherein, when the IC card is inserted to the IC card read out means, the data analyzing and controlling means is operative to extract assortments of the applications installed in the on-board short-range communication apparatus and assortments of the applications associated with the IC card that is inserted whereupon the data analyzing and controlling means permits the data informing means to provide information of the assortments of extracted applications, among the assortments of the applications, that are currently available in combination between the on-board short-range communication apparatus and the IC card.

12. An on-board short-range communication apparatus, for a vehicle, which is able to comply with a plurality of applications and performs data communication with an on-road device located in the vicinity of a road on which the vehicle travels, comprising:
data communication processing means for transmitting and receiving the data to and from the on-road device;
data analyzing and controlling means analyzing and controlling data processed with the data communication processing means;
data informing means providing information of resulting data processed with the data analyzing and controlling means; and
IC card read out means reading out an IC card prepared for the applications;
wherein, when the IC card is inserted to the IC card read out means, the data analyzing and controlling means is operative to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, the data analyzing and controlling means permits the data informing means to provide information of the presence of the non-available application.

13. An on-board short-range communication apparatus, for a vehicle, which is able to comply with a plurality of applications and performs data communication with an on-road device located in the vicinity of a road on which the vehicle travels, comprising:
data communication processing means for transmitting and receiving the data to and from the on-road device;
data analyzing and controlling means analyzing and controlling data processed with the data communication processing means;
data informing means providing information of resulting data processed with the data analyzing and controlling means; and
IC card read out means reading out an IC card prepared for the applications;
wherein, when the IC card is inserted to the IC card read out means, the data analyzing and controlling means is operative to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, the data analyzing and controlling means permits the data informing means to provide information of an assortment of the non-available application.

14. An on-board short-range communication apparatus, for a vehicle, which is able to comply with a plurality of applications and performs data communication with an on-road device located in the vicinity of a road on which the vehicle travels, comprising:
data communication processing means for transmitting and receiving the data to and from the on-road device;
data analyzing and controlling means analyzing and controlling data processed with the data communication processing means;
data informing means providing information of resulting data processed with the data analyzing and controlling means; and
IC card read out means reading out an IC card prepared for the applications;
wherein, when the IC card is inserted to the IC card read out means, the data analyzing and controlling means is operative to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated the on-board short-range communication apparatus but not with the IC card, the data analyzing and controlling means permits the data informing means to provide information of an assortment of the non-available application.

15. An on-board short-range communication apparatus, for a vehicle, which is able to comply with a plurality of applications and performs data communication with an on-road device located in the vicinity of a road on which the vehicle travels, comprising:
data communication processing means for transmitting and receiving the data to and from the on-road device;
data analyzing and controlling means analyzing and controlling data processed with the data communication processing means;
data informing means providing information of resulting data processed with the data analyzing and controlling means; and
IC card read out means reading out an IC card prepared for the applications;
wherein, when the IC card is inserted to the IC card read out means, the data analyzing and controlling means is operative to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated with the IC card but not with the on-board short-range communication apparatus, the data analyzing and controlling means permits the data informing means to provide information of an assortment of the non-available application.

16. An on-board short-range communication apparatus, for a vehicle, which is able to comply with a plurality of applications and performs data communication with an on-road device located in the vicinity of a road on which the vehicle travels, comprising:
data communication processing means for transmitting and receiving the data to and from the on-road device;
data analyzing and controlling means analyzing and controlling data processed with the data communication processing means; and
data informing means providing information of resulting data processed with the data analyzing and controlling means;
wherein, when the vehicle enters a communication area of the on-road device, the data analyzing and controlling means judges assortments of the applications of data that is transmitted to and received from the on-road device through the data communication processing means to permit the data informing means to provide information of the assortments of the applications.

17. A method of performing data communication between an on-board short-range communication apparatus for a vehicle, which is able to comply with a plurality of applications, and an on-road device located in the vicinity of a road on which the vehicle travels, the method comprising:
processing the data for transmitting and receiving the data to and from the on-road device;
analyzing and controlling data processed in the data processing step; and
providing information of resulting data processed in the data analyzing and controlling step;
wherein, when turning on an electric power supply of the on-board short-range communication apparatus, analyzing and controlling of data is executed to extract assortments of the applications installed in the on-board short-range communication apparatus and to permit information of the assortments of extracted applications to be provided.

18. A method of performing data communication between an on-board short-range communication apparatus for a vehicle, which is able to comply with a plurality of applications, and an on-road device located in the vicinity of a road on which the vehicle travels, the method comprising:
processing the data for transmitting and receiving the data to and from the on-road device;
analyzing and controlling data processed in the data processing step;
providing information of resulting data processed in the data analyzing and controlling step; and
reading out an IC card prepared for the applications;
wherein, when the IC card is inserted into a given position, analyzing and controlling is executed to extract assortments of the applications associated with the IC card that is inserted and to permit information of the assortments of extracted applications to be provided.

19. A method of performing data communication between an on-board short-range communication apparatus for a vehicle, which is able to comply with a plurality of applications, and an on-road device located in the vicinity of a road on which the vehicle travels, the method comprising:
processing the data for transmitting and receiving the data to and from the on-road device;
analyzing and controlling data processed in the data processing step;
providing information of resulting data processed in the data analyzing and controlling step; and
reading out an IC card prepared for the applications;
wherein, when the IC card is inserted into a given position, analyzing and controlling is executed to extract assortments of the applications installed in the on-board short-range communication apparatus and assortments of the applications associated with the IC card that is inserted whereupon analyzing and controlling is further executed to permit information of the assortments of extracted applications, among the assortments of the applications, that are currently available in combination between the on-board short-range communication apparatus and the IC card to be provided.

20. A method of performing data communication between an on-board short-range communication apparatus for a vehicle, which is able to comply with a plurality of applications, and an on-road device located in the vicinity of a road on which the vehicle travels, the method comprising:
processing the data for transmitting and receiving the data to and from the on-road device;
analyzing and controlling data processed in the data processing step;
providing information of resulting data processed in the data analyzing and controlling step; and
reading out an IC card prepared for the applications;
wherein, when the IC card is inserted into a given position, analyzing and controlling is executed to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, analyzing and controlling is further executed to permit information of the presence of the non-available application to be provided.

21. A method of performing data communication between an on-board short-range communication apparatus for a vehicle, which is able to comply with a plurality of applications, and an on-road device located in the vicinity of a road on which the vehicle travels, the method comprising:
processing the data for transmitting and receiving the data to and from the on-road device;
analyzing and controlling data processed in the data processing step;
providing information of resulting data processed in the data analyzing and controlling step; and
reading out an IC card prepared for the applications;
wherein, when the IC card is inserted into a given position, analyzing and controlling executed to extract assortments of the applications installed in the on-board short-range communication apparatus and assortments of the applications associated with the IC card that is inserted whereupon, when there is a non-available application, among the assortments of extracted applications, that is associated with either one of the on-board short-range communication apparatus and the IC card and currently has no availability in combination between the on-board short-range communication apparatus and the IC card, analyzing and controlling is further executed to permit information of an assortment of the non-available application to be provided.

22. A method of performing data communication between an on-board short-range communication apparatus for a vehicle, which is able to comply with a plurality of applications, and an on-road device located in the vicinity of a road on which the vehicle travels, the method comprising:
processing the data for transmitting and receiving the data to and from the on-road device;
analyzing and controlling data processed in the data processing step;
providing information of resulting data processed in the data analyzing and controlling step; and
reading out an IC card prepared for the applications;
wherein, when the IC card is inserted into a given position, analyzing and controlling is executed to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated the on-board short-range communication apparatus but not with the IC card, analyzing and controlling is further executed to permit information of an assortment of the non-available application to be provided.

23. A method of performing data communication between an on-board short-range communication apparatus for a vehicle, which is able to comply with a plurality of applications, and an on-road device located in the vicinity of a road on which the vehicle travels, the method comprising:
processing the data for transmitting and receiving the data to and from the on-road device;
analyzing and controlling data processed in the data processing step;
providing information of resulting data processed in the data analyzing and controlling step; and
reading out an IC card prepared for the applications;
wherein, when the IC card is inserted into a given position, analyzing and controlling is executed to extract assortments of the applications installed in the on-board short-range communication apparatus and assortments of the applications associated with the IC card that is inserted whereupon, when there is a non-available application, among the assortments of extracted applications, that currently has no availability in combination between the on-board short-range communication apparatus and the IC card due to the fact that the non-available application is associated with the IC card but not with the on-board short-range communication apparatus, analyzing and controlling is further executed to permit information of an assortment of the non-available application to be provided.

24. A method of performing data communication between an on-board short-range communication apparatus for a vehicle, which is able to comply with a plurality of applications, and an on-road device located in the vicinity of a road on which the vehicle travels, the method comprising:
processing data communication for transmitting and receiving the data to and from the on-road device;
analyzing and controlling data processed in the data communication processing step; and
providing information of resulting data processed in the analyzing and controlling step;
wherein, when the vehicle enters a communication area of the on-road device, analyzing and controlling is executed to judge assortments of the applications of data that is transmitted to and received from the on-road device in the data communication processing step to permit information of the assortments of the applications to be provided.
